(19) United States
(12) Patent Application Publication
(10) Pub. No.: US 2011/0014325 A1
(43) Pub. Date: Jan. 20, 2011

(54) Smore Centers

(76) Inventor: Michael J. Ure, Cupertino, CA (US)

Correspondence Address: MICHAEL J. URE, 10518 PHIL PLACE, CUPERTINO, CA, 95014, US

(21) Appl. No.: 12/504,915

(22) Filed: Jul. 17, 2009

(51) Int. Cl. A23G 1/54

(52) U.S. Cl. 426/76; 426/272

(57) ABSTRACT

A chocolate bar or the like is configured to allow squares to be broken off. On the rear side of each of the squares, a centered indentation is provided. This allows a square to be skewered without breaking. Two or more squares are skewered between two marshmallows, and the assembly is roasted. In the course of roasting, the chocolate is heated but retains its form. The roasted combination is placed between two full graham crackers. The skewer may be worked back and forth a bit to distribute the melted chocolate. The result is an incomparably delicious and kid-friendly campfire smore.

Traditional campfire smores are sub-par for the reason that the chocolate usually remains unmelted.

To overcome this drawback, reconfigure a chocolate bar such as the familiar Hershey bar to produce a version (Smorsels™) especially well-suited to making delicious campfire smores.

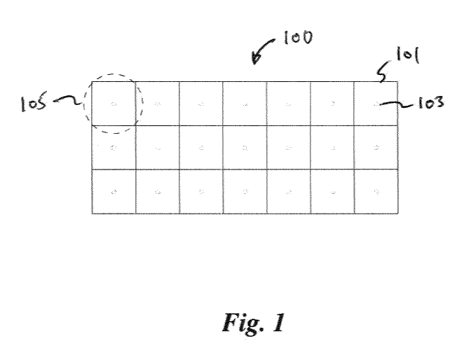

FIG. 1 is a plan diagram of a chocolate bar configured for making delicious campfire smores.

FIG. 2 is a diagram illustrating skewering of an assembly of marshmallows and chocolate pieces preparatory to roasting.

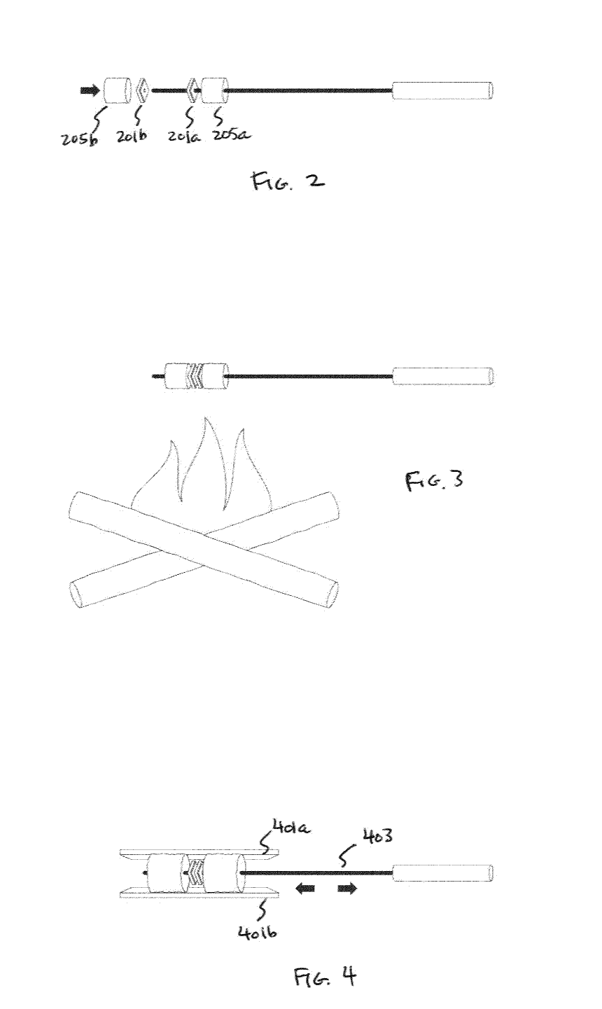

FIG. 3 is a diagram illustrating roasting of the assembly.

FIG. 4 is a diagram illustrating sandwiching of the roasted assembly between crackers.

The bar 100 (FIG. 1) is configured to allow squares 101 (in one embodiment, approximately 1″ squares, ±50%) to be broken off. A cross section of a marshmallow 105 is shown in dotted lines for comparison. On the rear side of each of the squares, a centered indentation 103 is provided. This allows a square to be skewered without breaking. Two or more squares 201a, 201b (FIG. 2) are skewered between two marshmallows 205a, 205b, and the assembly is roasted (FIG. 3). In the course of roasting, the chocolate is heated but retains its form. The roasted combination is placed between two full graham crackers 401a, 401b (FIG. 4). The skewer 403 may be worked back and forth a bit to distribute the melted chocolate. The result is an incomparably delicious and kid-friendly campfire smore.

Smorsel bars of different flavors may be provided (e.g., mint chocolate). If desired, interlocking features may be provided between the front and back of squares to ensure uniform, secure rotation during roasting. Also, instead of bar form, separate squares may be sold by the bag. The chocolate pieces can of course be made round or be made to have any of a variety of shapes.

What is claimed is:

1. A method of making a confection using chocolate pieces having pre-formed indentations, comprising:
skewering a first marshmallow;
skewering one or more chocolate pieces having pre-formed indentations;
skewering a second marshmallow; and
roasting the marshmallows and the chocolate pieces.

2. The method of claim 1, comprising, following roasting, sandwiching the marshmallows and the chocolate pieces between two crackers.

3. The method of claim 2, wherein the pre-formed indentations comprise through-holes.

4. A chocolate bar comprising break lines enabling the chocolate bar to be broken into pieces about one inch square; and
indentations such that an indentation in a piece of chocolate broken from the chocolate bar enables the piece of chocolate to be skewered without breaking.

5. The chocolate bar of claim 4 wherein the indentation comprises a through hole.

6. Chocolate pieces, each chocolate piece being about one inch square, each chocolate piece having an indentation enabling the chocolate piece to be skewered without breaking.

7. The chocolate pieces of claim 6, wherein the indentation comprises a through hole.
